(19) United States
(12) Patent Application Publication
(10) Pub. No.: US 2001/0014269 A1
(43) Pub. Date: Aug. 16, 2001

(54) High throughput wafer transfer mechanism

(76) Inventors: Robert Hartlage, Santa Clara, CA (US); Phil Salzman, San Jose, CA (US)

Correspondence Address: PATENT COUNSEL, APPLIED MATERIALS, INC., Legal Affairs Department, P.O.Box 450 A, Santa Clara, CA, 95052, US

(21) Appl. No.: 09/819,215

(22) Filed: Mar. 28, 2001

Related U.S. Application Data
(62) Division of application No. 08/909,032, filed on Aug. 11, 1997.

(51) Int. Cl. B65G 1/00

(52) U.S. Cl. 414/217

(57) ABSTRACT

Disclosed is an apparatus and method for transporting objects between process chambers, and for transferring objects to and from process chambers with minimal handoff operations. The invention discloses a trolley type system (rail and car) for moving an external magnet adjacent a transfer chamber so as to cause corresponding movement of an object transport device contained within the transfer chamber, via magnetic coupling. In one aspect, the object transport device is a blade type device that may transfer the object directly into a process chamber, and in a second aspect the object transport device is a telescoping type device that may extend between transport planes and chamber load/unload planes. A further aspect of the invention includes the networking of numerous transport and processing systems. A network node is provided that has rotatably mounted rails for altering the direction of the trolley car's movement.

This application is a division of U.S. Pat. application Ser. No. 08/909,032, filed Aug. 11, 1997, the entire contents of which are hereby incorporated by reference herein.

### BACKGROUND OF THE INVENTION

The semiconductor fabrication industry continuously seeks new methods and apparatuses to reduce device fabrication costs. Because equipment and labor costs are distributed over the total number of devices produced, fabrication costs can be reduced by reducing equipment costs (reducing component costs and system footprint) and by increasing throughput.

The majority of semiconductor device fabrication systems presently in use are based on the central transfer robot approach. In operation, the central transfer robot can present a significant bottleneck, particularly as process times shorten. Accordingly a number of linear systems have been proposed to eliminate the central transfer robot bottleneck. A particularly advantageous system is disclosed in commonly assigned co-pending application Ser. No. 08/877,676 entitled APPARATUS AND METHOD FOR AUTOMATED CASSETTE HANDLING filed Jun. 17, 1997. In its preferred embodiment this system involves linear transfer of wafer cassettes by an overhead track system; the cassette is then transferred to an elevator/indexer and lowered to a position where one or more x-axis wafer handlers transfer wafers from the wafer cassette to one or more respective process chambers. The 08/877,676 system eliminates the transfer robot bottleneck and provides a significant throughput increase in a reduced footprint configuration. However, as each semiconductor fabrication facility presents unique space and processing limitations, a variety of fabrication equipment configurations are required, each providing its own unique advantages.

Accordingly, a need exists for additional linear fabrication equipment configurations, that maintain high throughput and small footprint while reducing particle generation and simplifying equipment. Particularly, a need exists for a system that has fewer handoffs between object transfer devices, and therefore experiences fewer handoff delays, fewer handoff errors, less particle generation and less wafer breakage.

### SUMMARY OF THE INVENTION

The present invention provides a semiconductor device transport system that is freely configurable to accommodate space limitations, that reduces wafer handoff operations and that maintains the majority of moving parts associated with wafer transport outside of the vacuum chamber. Wafers may be transported individually without encasement in a protective pod, along paths that may vary greatly according to the needs of the specific semiconductor device fabrication facility.

To achieve these advantages, the present invention employs magnetic coupling between an object transport mechanism contained within a transfer chamber, and a mobile external magnet that travels along a track outside of and parallel to the transfer chamber (i.e., a trolley system). A large percentage of the moving parts are therefore maintained outside of the transfer chamber. In one aspect no internal track is employed, and the object transport device is both suspended (i.e., magnetically levitated) and propelled from one location to the next via the external magnet. In another aspect the object transport device is coupled to a highly clean track contained within the vacuum chamber (i.e., an internal track). In this manner the object is supported by the internal track, and propelled along the track by magnetic coupling with the external magnet.

Specific configurations of the object transport mechanism and the transfer chamber provide additional advantages. For instance, in a first aspect the invention employs an extended blade type object transport mechanism that may directly insert an object within a processing chamber, thereby eliminating the need for an intermediate handoff.

In a second aspect the object transport mechanism telescopes between a plurality of planes thereby reducing the number of handoff delays experienced by conventional multi-plane systems. Preferably all process chambers within the inventive system are coupled along planes that are distinct from the planes used for object transport. Thus, object transport mechanisms may travel along one plane, while objects are transferred to or from a process chamber in another plane. In this manner, object transport and process chamber load/unload may occur asynchronously. Because objects may overlap as they pass each other a double wide transport path (i.e., a path twice the diameter of the transported object) is not required. The multi-plane operation of the present invention therefore minimizes footprint.

A system that employs the inventive telescoping object transport mechanism preferably includes a plurality of transfer blades for transferring objects between an object transport mechanism and a process chamber, a load lock, or an object transport mechanism of a remote object transport system. Thus, a plurality of object transport systems may be easily interconnected to form a semiconductor device transport and process network. Further, in this aspect of the invention the external magnet may be configured to control not only object transport mechanism travel but also to control object transport mechanism telescoping.

In a third aspect of the invention, inclusion of transfer nodes may be employed to further enhance the flexibility of both the first and the second aspects of the invention. Such transfer nodes comprise a segment of the external track that is rotatably mounted parallel to a transfer chamber portion having a diameter roughly equal to the length of the rotatable external track segment. By rotating the track segment the external magnet's direction of travel, and the direction of travel of the object transport mechanism coupled thereto, may be easily altered.

Accordingly the present invention responds to the needs of the semiconductor device fabrication field with a beneficial new approach to device transport. The present invention reduces wafer transfer operations, the equipment needed therefore, and the particles generated thereby. The present invention is therefore particularly advantageous for use in highly clean, footprint conscious applications.

Other objects, features and advantages of the present invention will become more fully apparent from the following detailed description of the preferred embodiments, the appended claims and the accompanying drawings.

### BRIEF DESCRIPTION OF THE DRAWINGS

FIG. 1A is a side elevational view of a overhead trolley system of the present invention;

FIG. 1B is a side elevational view of a bottom type trolley system of the present invention;

FIG. 2A is a top plan view of an object transport mechanism configured for use with the overhead trolley system of FIG. 1A;

FIG. 2B is a side elevational view of the object transport mechanism of FIG. 2A, configured for use with the overhead trolley system of FIG. 1A;

FIG. 3A is a side elevational view of an object transport mechanism configured for use with the bottom-type trolley system of FIG. 1B;

FIG. 3B is a partial bottom plan view of the object transport mechanism of FIG. 3A, configured for use with the bottom-type trolley system of FIG. 1B;

FIG. 4 is a top plan view of a semiconductor device fabrication system configured for use with the object transport mechanism of FIGS. 2A and 2B;

FIG. 5 is a side elevational view of a transfer chamber configured for use with the object transport mechanism of FIGS. 3A and 3B;

FIGS. 6A and 6B are top plan views of an object transport and process system that employs the transfer chamber of FIG. 5;

FIGS. 7A-7H are top plan views of the object transport and process system of FIGS. 6A and 6B, useful for describing object transport therethrough; and

FIG. 8 is a top plan view of a network of the transport and process systems of FIGS. 6A and 6B.

### DETAILED DESCRIPTION OF THE PREFERRED EMBODIMENTS

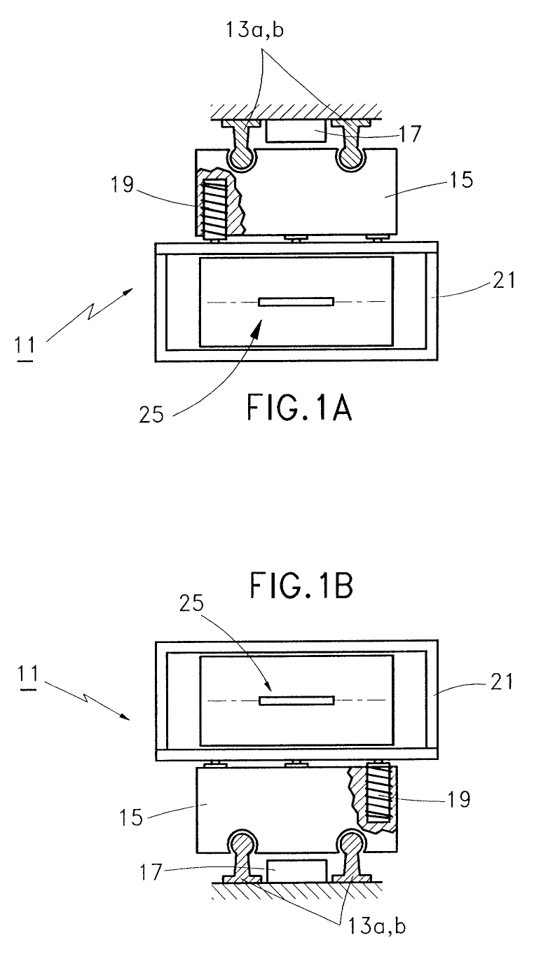

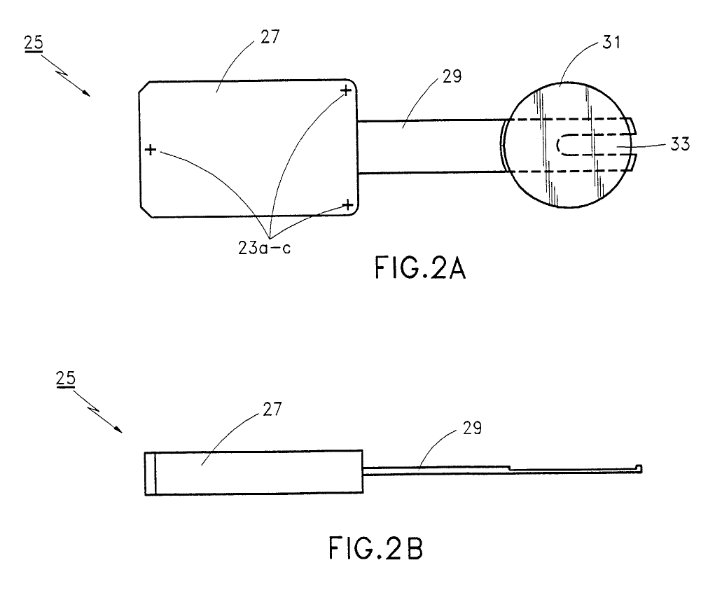

FIG. 1A shows an exemplary trolley system 11 of the present invention configured for overhead magnetic coupling. The trolley system 11 is an overhead system that employs two guide rails 13a-b as an overhead track. In practice the guide rails 13a-b may run in any configuration desired. A trolley car 15 is slidably coupled to the guide rails 13a-b and comprises a linear motor 17 (preferably a stepper motor) and at least one electromagnet 19. Preferably the trolley car 15 has three electromagnets 19a-c (represented generally by reference numeral 19). A transfer chamber, preferably a vacuum chamber 21, runs parallel to the guide rails 13a-b and in sufficient proximity to provide operative magnetic coupling between the electromagnets 19 mounted on the trolley car 15, and one or more permanent magnets 23 mounted on an object transport mechanism 25, shown in detail in FIGS. 2A and 2B. An operating description of the trolley system 11 will therefore be provided below in conjunction with FIGS. 2A and 2B. FIG. 1B shows the trolley system 11 configured to provide magnetic coupling through the bottom of a transfer chamber (i.e., a bottom type trolley system 11). For convenience, throughout the figures like components are labeled with common numerals.

FIGS. 2A and 2B are a top plan view and a side elevational view, respectively, which show a preferred configuration of an object transport mechanism 25 for use with the overhead trolley system 11 of FIG. 1A. The object transport mechanism 25 comprises a body 27 and a blade 29 coupled thereto. Three permanent magnets 23a-c are positioned in a spaced relationship on the surface of the body 27. The blade 29 is shown supporting a wafer 31. The blade 29 preferably comprises a slot 33 to facilitate wafer transfer to and from a conventional three pin wafer lift mechanism. As shown in FIG. 2B, the portion of the blade 29 that supports the wafer 31 is recessed in order to prevent the wafer 31 from sliding off of the blade 29 during transport.

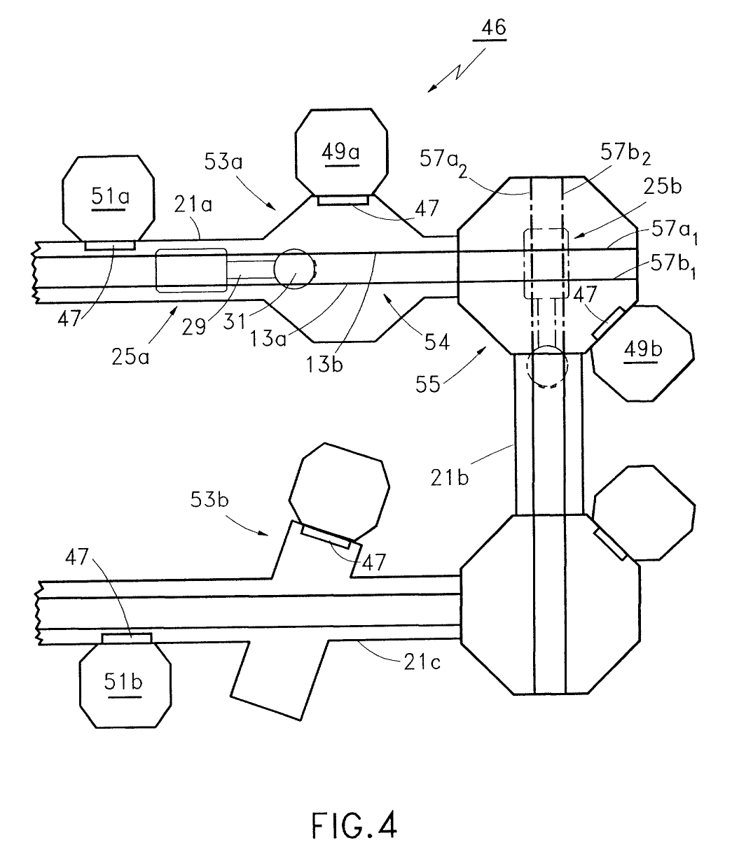

In operation, with reference to FIG. 1A, the object transport mechanism 25 of FIGS. 2A and 2B is propelled through the vacuum chamber 21 along a desired path in the following manner. First, in order to maintain the object transport mechanism 25 suspended within the vacuum chamber 21, the three electromagnets 19a-c mounted on the trolley car 15 are energized by a controller (not shown) mounted on the trolley car 15. The magnetic attraction between the electromagnets 19a-c and the respective permanent magnets 23a-c mounted on the body 27 of the object transport mechanism 25 causes the object transport mechanism 25 to levitate. In order to ensure that the object transport mechanism 25 is level (e.g., parallel with the vacuum chamber 21's ceiling) three conventional sensors (not shown) may be appropriately positioned on the trolley car 15. In this manner, a controller (not shown) may adjust the magnetization levels of each of the permanent magnets 23a-c based on distance information provided by the sensors, and thereby can maintain the object transport mechanism 25 in a level position, or can cause the object transport mechanism 25 to tip forward to facilitate transfer of the wafer 31, etc. The linear motor 17 is then engaged, causing the trolley car 15 to travel along the guide rails 13a-b. As the trolley car 15 travels forward, the attraction between the electromagnets 19a-c and the permanent magnets 23a-c causes the object transport mechanism 25 to be propelled forward. In this manner the overhead trolley system 11 of FIG. 1A and the object transport mechanism 25 of FIGS. 2A and 2B may be used to achieve magnetic levitation and transport within a semiconductor device fabrication system as describe in detail with reference to FIG. 4.

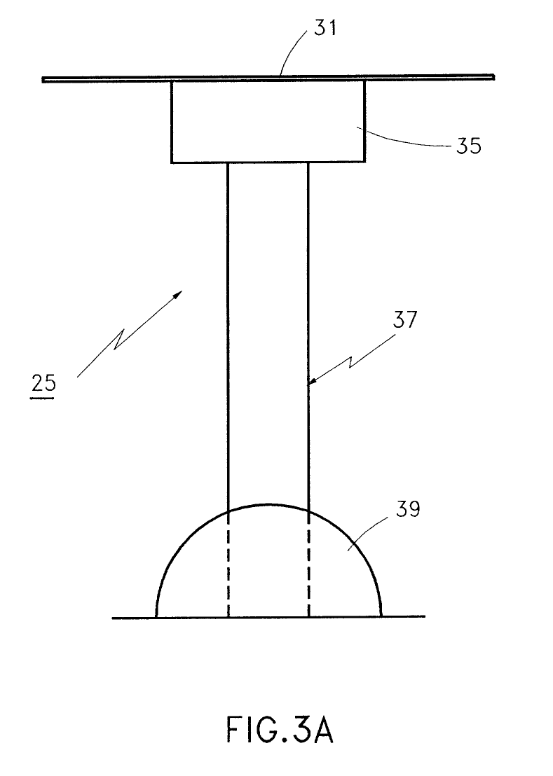

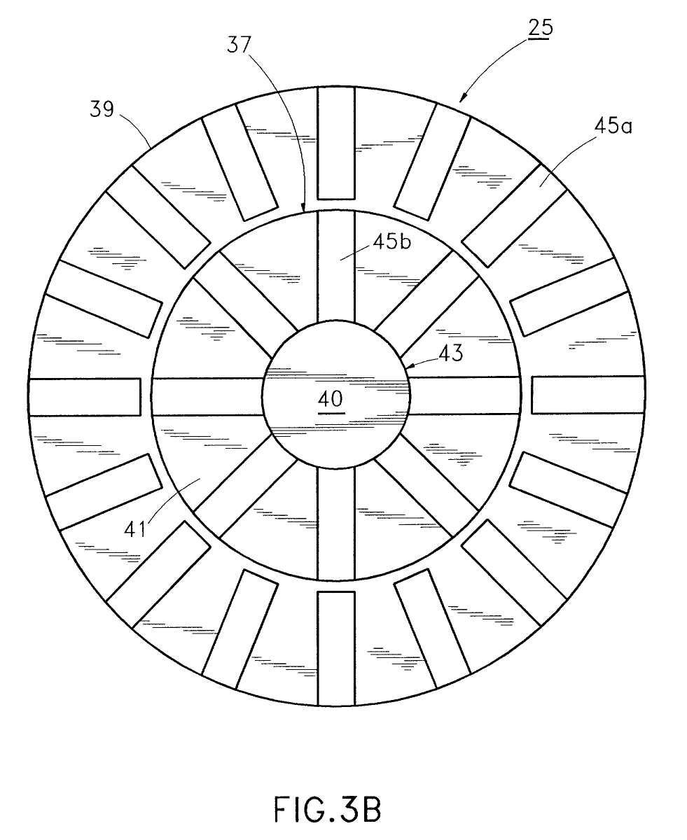

FIGS. 3A and 3B are a side elevational view and a partial bottom plan view, respectively, of the object transport mechanism 25, which show a preferred configuration of the object transport mechanism 25 for use with the bottom type trolley system 11 of FIG. 1B. With reference to FIG. 3A, the object transport mechanism 25 comprises a support portion 35 mounted atop a telescoping portion 37. A base portion 39 couples the telescoping portion 37 at an end opposite the support portion 35. The size of the support portion 35 is dependent upon the size of the object to be transported. As shown in FIG. 3A, the support portion 35 supports a wafer 31. The support portion 35 preferably comprises a lifting mechanism (not shown) such as a wafer lift hoop or wafer lift pins, conventionally known in the art. Incorporation of such a lifting mechanism facilitates wafer handoffs to and from the object transport mechanism 25.

The telescoping portion 37 may comprise any known extension apparatus, however when employed in semiconductor device fabrication applications, the telescoping portion 37 is preferably configured so as to minimize particle generation. For instance, with reference to FIG. 3B which shows a bottom plan view of the telescoping portion 37 and the base portion 39, the telescoping portion 37 comprises an inner shaft 40 translatably mounted within a hollow outer shaft 41. The inner surface of the outer shaft 41 and the outer surface of the inner shaft 40 are thread so as to matingly couple at an interface represented generally by the reference numeral 43. A first row of permanent magnets 45a is mounted on the bottom surface of the base portion 39, and a second row of permanent magnets 45b is mounted on the bottom surface of the outer shaft 41.

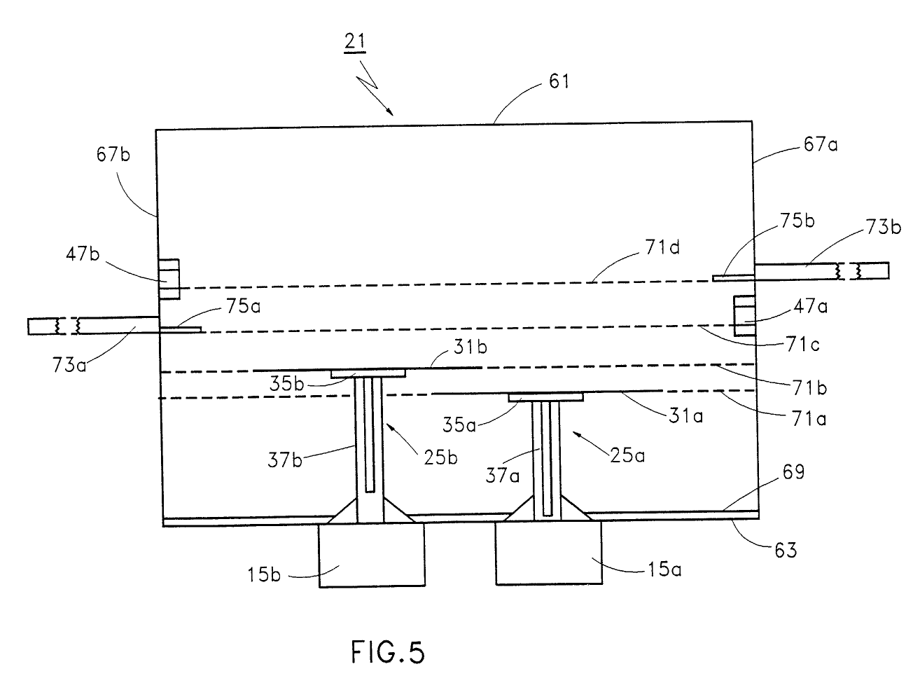

In operation, with reference to FIG. 1B, the object transport mechanism 25 of FIGS. 3A and 3B is propelled through the vacuum chamber 21 along an internal track (shown and described with reference to FIG. 5) in the following manner. First, in order to attract the object transport mechanism 25 to the trolley car 15, a first electromagnet 19a (represented generally by reference numeral 19 in FIG. 1B) is energized by a controller (not shown) mounted on the trolley car 15. A magnetic attraction is generated between the first row of permanent magnets 45a and the first electromagnet 19a, which are positioned adjacent each other through the floor of the vacuum chamber 21. (It will be understood that as an alternative to the first and second electromagnets 19a-b, a first row of permanent magnets and a second row of permanent magnets configured similarly to the configuration of the first and second rows of permanent magnets 45a-b, respectively, may be employed.)

The linear motor 17 is then engaged causing the trolley car 15 to travel along the guide rails 13a-b. As the trolley car 15 travels forward, the attraction between the first electromagnet 19a and the first row of permanent magnets 45a causes the object transport mechanism 25 to be propelled forward. When the object transport mechanism 25 approaches a process chamber that is located in a higher plane (as described in greater detail with reference to FIGS. 5-7), a controller (not shown) on the trolley car 15 energizes a second electromagnet 19b (positioned adjacent the second row of permanent magnets 45b through the floor of the vacuum chamber 21) and causes the second electromagnet 19b to rotate.

As the second electromagnet 19b rotates, the inner shaft 40 rotates and elevates in a screw-like manner via the interface 43. (It should be noted, with reference to FIG. 3A, that a bellows may be mounted between the support portion 35 and the outer shaft 41 in order to contain any particles that may be generated by the extension of the telescoping portion 37.) In a similar manner, if a particular wafer alignment is desired, the first electromagnet 19a may rotate, thus causing the base portion 39, the support portion 35 and the wafer 31 positioned thereon, to rotate until a desired wafer alignment is achieved. A conventional alignment sensor may be mounted on the trolley car 15 to sense the amount of rotation required and to provide that information to the controller (not shown) which causes the first electromagnet 19a to rotate.

FIG. 4 is a top plan view of an object transport and process system 46 that employs the trolley system 11 of FIG. 1A and the object transport mechanism 25 of FIGS. 2A and 2B. Although not depicted by FIG. 4, the vacuum chamber 21 (shown in FIG. 4 as vacuum chamber segments 21a-c) may extend along any path through any number of planes. Preferably the vacuum chamber 21 is slightly wider than the width of the object to be transported. The vacuum chamber 21 has a plurality of slit valves 47 located in a spaced relationship along the length of the vacuum chamber 21. Coupled to the slit valves 47 are a plurality of process chambers 49, a first load lock 51a, and a second load lock 51b. In order to enable the object transport mechanism 25 to insert the wafer 31 within a given process chamber 49 a widened vacuum chamber portion 53 may be positioned opposite each process chamber 49. The guide rails 13a-b of the trolley system 11 (see FIG. 1A) that extend above the widened vacuum chamber portion 53 are a linear segment that is rotatably mounted (i.e., a rotatable widened track portion 54). The widened vacuum chamber portion 53 may assume a variety of forms, as identified by reference numerals 53a and 53b of FIG. 4.

In order to provide greater flexibility a first vacuum chamber segment 21a and a second vacuum chamber 21b are interconnected via a network node 55. The network node 55 preferably comprises eight sides each of which may comprise one or more slit valves 47 which further may be coupled to a vacuum chamber (e.g., to a second vacuum chamber segment 21b as shown in FIG. 4), to a process chamber 49, or to a load lock 51. The network node 55 preferably comprises a multi-sided (preferably octagonal) vacuum chamber. The guide rails 13a-b of the trolley system 11 that extend above the network node 55 are a linear segment that is rotatably mounted (i.e., a rotatable rail segment 57) above the octagonal network node 55. Thus, (as explained in detail below) the vacuum chamber segments 21a-c may extend in numerous directions, and the object transport mechanism 25 may easily pass therebetween without requiring a more elaborate crossover mechanism such as those conventionally employed for train track crossovers.

In operation a cassette of wafers is loaded into the first load lock 51a and pumped down to a vacuum pressure. When the desired vacuum pressure is achieved, the first load lock 51a's slit valve 47 opens and the blade 29 of the first object transport mechanism 25a extends within the first load lock 51a and picks up a wafer 31. In order to pick up the wafer 31, the first object transport mechanism 25a may tilt via appropriate adjustment of the magnetization levels of the three electromagnets 19a-c mounted on the trolley car 15 (see FIGS. 1A, 2A and 2B). Alternatively, conventional wafer transfer blades, wafer lift pins or the like may be employed. To receive a wafer from conventional wafer lift pins, the blade 29 of the first object transport mechanism 25a extends under the wafer 31, between the wafer lift pins (not shown). The slot 33 (see FIG. 2A) enables the blade 29 to receive the wafer 31 from wafer lift pin configurations having a central or central and radially opposed lift pin.

After the wafer 31 is picked up, the trolley car 15 travels along the guide rails 13a-b to the first widened vacuum chamber portion 53a causing the first object transport mechanism 25a to be magnetically propelled along the guide rails 13a-b (as described with reference to FIGS. 2A and 2B) to the first process chamber 49a. The first object transport mechanism 25a then rotates via rotation of the rotatable widened track portion 54 or via a conventional external track crossover mechanism (not shown). The slit valve 47 of the first process chamber 49a opens and the first object transport mechanism 25a moves forward such that the blade 29 extends through the slit valve 47 and positions the wafer 31 above a wafer pedestal (not shown) contained within the first process chamber 49a. The wafer 31 is then transferred to the wafer pedestal via conventional wafer lift mechanisms or appropriate tilting of the first object transport mechanism 25a, as described previously. The first object transport mechanism 25a moves backward to exit the first process chamber 49a, and may then continue traveling along the first vacuum chamber segment 21a or may wait while the wafer 31 is processed within the first process chamber 49a. Meanwhile other object transport mechanisms 25 within the object transport and process system 46 asynchronously transport other wafers to and from process chambers and through the network nodes 55 to other vacuum chamber segments 21b-c.

Transfer through the network node 55 is best understood with reference to the second object transport mechanism 25b (shown in phantom). In order to travel from the first vacuum chamber segment 21a to the second vacuum chamber segment 21b, the second object transport mechanism 25b enters the network node 55 via the rotatable rail segment 57a-b which is in a first position indicated as 57_{a-b1}. After the second object transport mechanism 25b is completely within the network node 55, the rotatable rail segment 57a-b rotates to a second position (indicated as 57_{a-b2}) carrying the second object transport mechanism 25b into position for entry into the second vacuum chamber segment 21b, as shown in phantom. The trolley car 15 then travels forward off of the rotatable rail segment 57a-b and onto the guide rails 13a-b of the second vacuum chamber segment 21b. In this manner, numerous object transport and process systems 46 can be networked quickly and easily through the network node 55, and/or numerous process chambers 49 can be coupled to the network node 55 for quick and mechanically simple wafer transfer therebetween.

In FIG. 5 the vacuum chamber 21 is configured for particularly advantageous operation when employed in conjunction with the bottom type trolley system 11 of FIG. 1B and with the object transport mechanism 25 of FIGS. 3A and 3B.

The inventive vacuum chamber 21 comprises a ceiling 61, a floor 63 and any number of side walls 67a-b. An internal track represented generally by reference numeral 69 preferably is coupled to the floor 63. Preferably the internal track 69 is a clean semiconductor fabrication grade track such as the commercially available roller tracks manufactured by Middlesex General Industries, Inc. under the trademark CLEAN-DRIVE™.

The vacuum chamber 21 has a plurality of slit valves 47a-b located along four planes represented by dotted lines 71a-d. Operatively coupled to the internal track 69 are one or more object transport mechanisms 25 described in detail with reference to FIGS. 3A and 3B. However, in general, the object transport mechanisms 25 comprise a telescoping portion 37 for telescoping between each of the planes 71a-d and a support portion 35 for supporting an object to be transferred. The planes 71a-d are distally located such that at least a thickness of an object to be transported (e.g., a semiconductor wafer) exists between adjacent planes (e.g., between the first plane 71a and the second plane 71b). A first wafer 31a mounted on a first object transport mechanism 25a traveling in the first plane 71a may thus pass a second wafer mounted on a second object transport mechanism 25b traveling in the second plane 71b, as shown in FIG. 5.

A plurality of pockets 73 having a transfer blade 75 movably mounted therein are positioned along a side wall 67 opposite a given slit valve 47, and in the same plane 71 as the given slit valve 47. Thus, the first transfer blade 75a is mounted in the third plane 71c along the side wall 67b opposite the first slit valve 47a, and the second transfer blade 75b is mounted in the fourth plane 71d along the side wall 67a opposite the second slit valve 47b. Each transfer blade 75 is preferably magnetically coupled to an air cylinder type driving mechanism (not shown) mounted outside the pocket 73. Such a device is inexpensive and can employ a mechanical stop outside the pocket 73 to appropriately limit the motion of the transfer blade 75. In this manner, the need for a more expensive positionable drive (such as a stepper type motor) is eliminated.

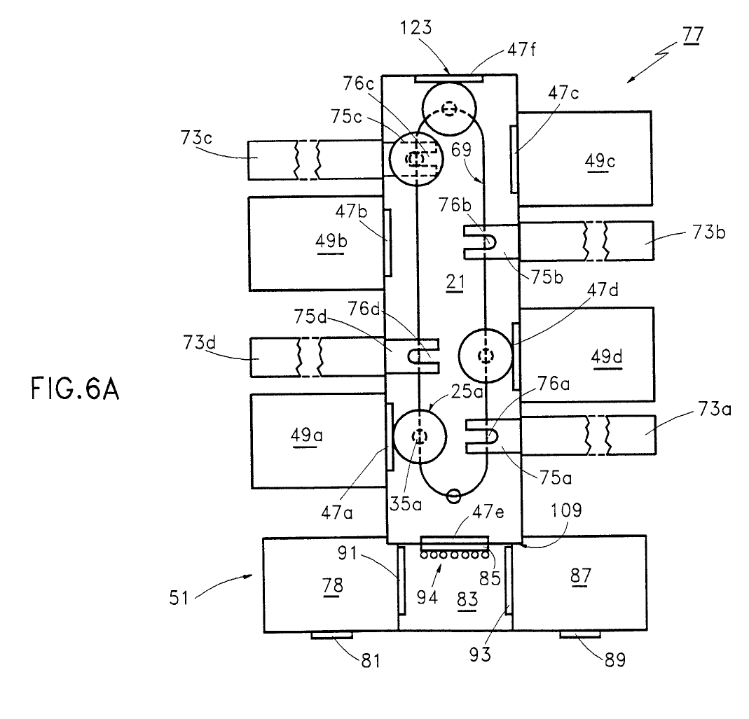

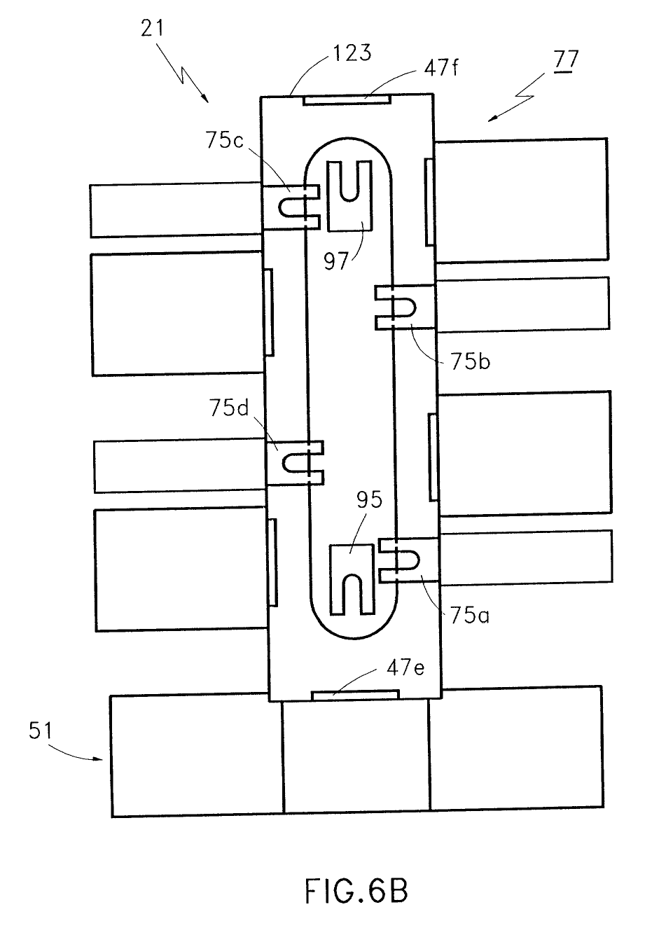

FIGS. 6A and 6B are top plan views of an object transport and process system 77 comprising the vacuum chamber 21 of FIG. 5. As shown in FIGS. 6A and 6B, each transfer blade 75a-d has a slot 76a-d of sufficient size to receive the support portion 35 of an object transport mechanism 25 (see FIG. 3A).

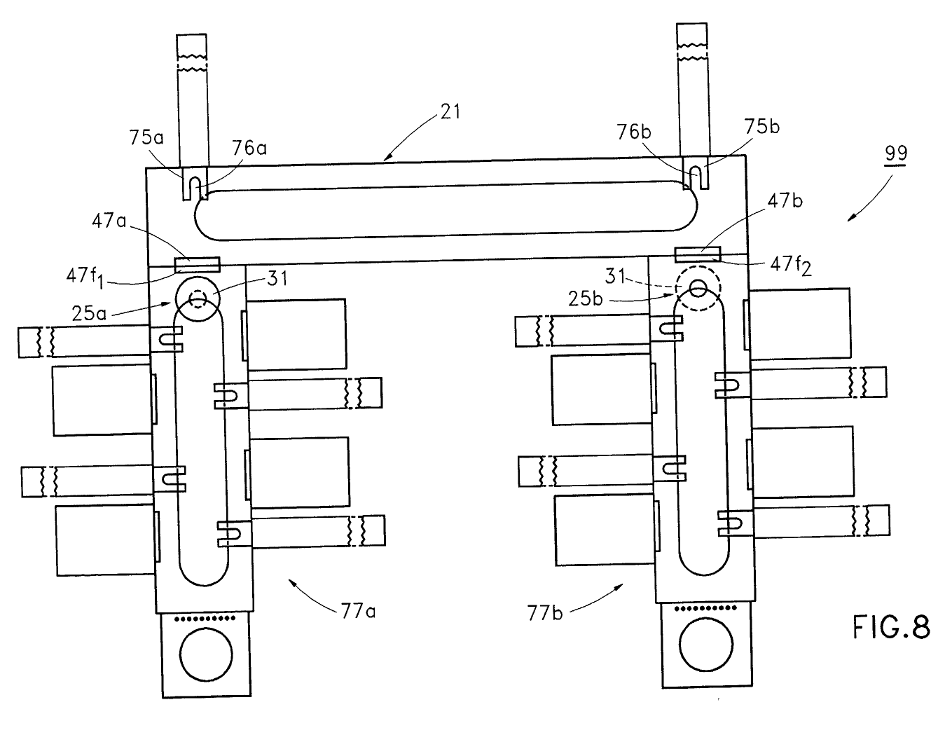

Each of the slit valves 47a-d are operatively coupled to a load lock 51, a process chamber 49a-d, a network node 55 (shown only in FIG. 4), or the like, to form the object transport and process system 77 of FIGS. 6A and 6B. The exemplary configuration of FIGS. 6A and 6B is described with reference to the plurality of planes 71a-d shown in the side elevational view of FIG. 5. Preferably, within the object transport and process system 77 all load locks 51, network nodes 55 (see FIG. 4), remote transfer chambers 59 (see FIG. 8), and all process chambers 49a-d are coupled along two of the planes 71a-d (e.g., along the third plane 71c and the fourth plane 71d). The remaining two planes (e.g., the first plane 71a and the second plane 71b are therefore reserved for object transport. In this manner each object may be transported and processed asynchronously, without regard for the transport and processing of other objects.

The first process chamber 49a and the third process chamber 49c are coupled (via the first and second slit valves 47a, 47b, respectively) along the third plane 71c, so as not to obstruct the movement of a load lock transfer blade 95 and a network transfer blade 97 which are coupled along the fourth plane 71d, as described further with reference to FIG. 6B. (To avoid confusion, it should be noted that the configurations of FIGS. 5 and 6 differ.)

The second process chamber 49b and the fourth process chamber 49d are coupled along the fourth plane 71d via the second and fourth slit valves 47b, 47d, respectively. Thus, process chambers 49 located adjacent and opposite each other (e.g., the first process chamber 49a and the fourth process chamber 49d) are coupled along different planes and therefore allow wafers to be concurrently loaded to and from adjacent and opposite process chambers (e.g., the first and fourth process chambers 49a, 49d) without collision. The load lock 51 is coupled along the fourth plane 71d via the fifth slit valve 47e. A remote object transport and process system (not shown), a remote vacuum chamber (shown as 21 in FIG. 8) or a network node 55 (shown and described with reference to FIG. 4) optionally may be coupled to the vacuum chamber 21 via the sixth slit valve 47f.

A first transfer blade 75a is coupled along the third plane 71c at a position opposite the first process chamber 49a, and a second transfer blade 75b is coupled along the fourth plane 71d at a position opposite the second process chamber 49b. A third transfer blade 75c is coupled along the third plane 71c at a position opposite the third process chamber 49c, and a fourth transfer blade 75d is coupled along the fourth plane 71d at a position opposite the fourth process chamber 49d.

The load lock 51 preferably comprises three chambers, a load chamber 78 having a load port 81, an exchange chamber 83 operatively coupled to the load chamber 78, having an exchange port 85 (for loading wafers to and from the vacuum chamber 21), and an unload chamber 87 operatively coupled to the exchange chamber 83, having an unload port 89. The exchange chamber 83 is coupled to the load chamber 78 and the unload chamber 87 via first and second sealable ports 91 and 93, respectively, such that each chamber (load, exchange and unload) may operate independently. The exchange chamber 83 may also include a plurality of center/flat sensors 94 operatively coupled along the exchange port 85.

Further, with reference to FIG. 6B, a load lock transfer blade 95 is mounted in the fourth plane 71d opposite the load lock 51 and, preferably, a network transfer blade 97 is mounted in the fourth plane 71d opposite the sixth slit valve 47f. The load lock transfer blade 95 and the network transfer blade 97 are similar to the transfer blades 75a-d, however the load lock transfer blade 95 and the network transfer blade 97 are mounted within the vacuum chamber 21 and are preferably magnetically coupled through the ceiling 61 (see FIG. 5) to an air cylinder type driving mechanism (not shown) mounted on top of (and outside of) the vacuum chamber 21.

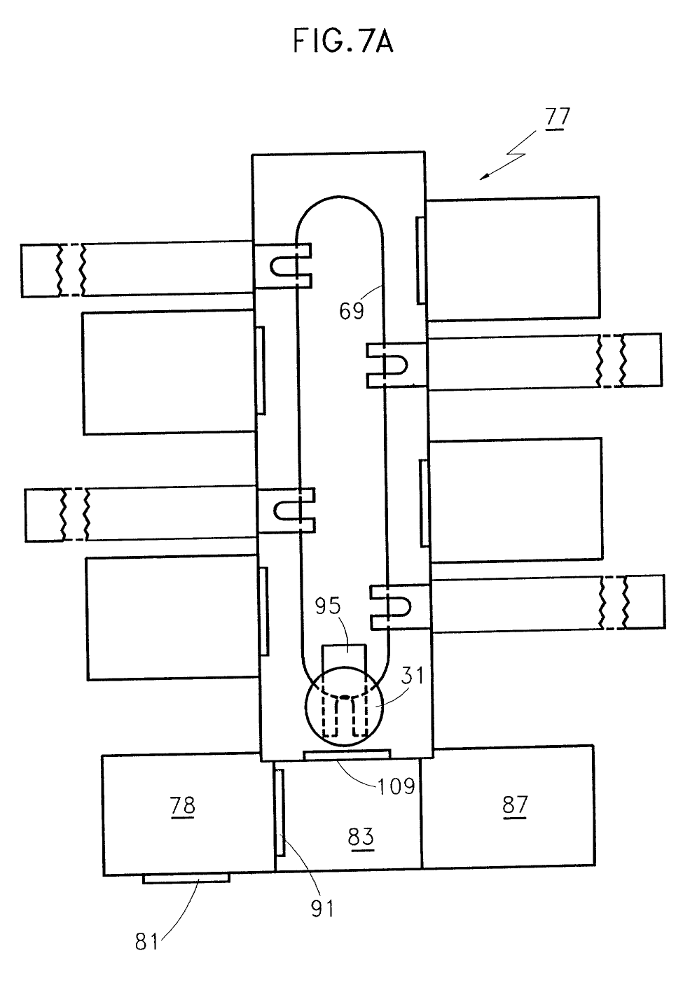

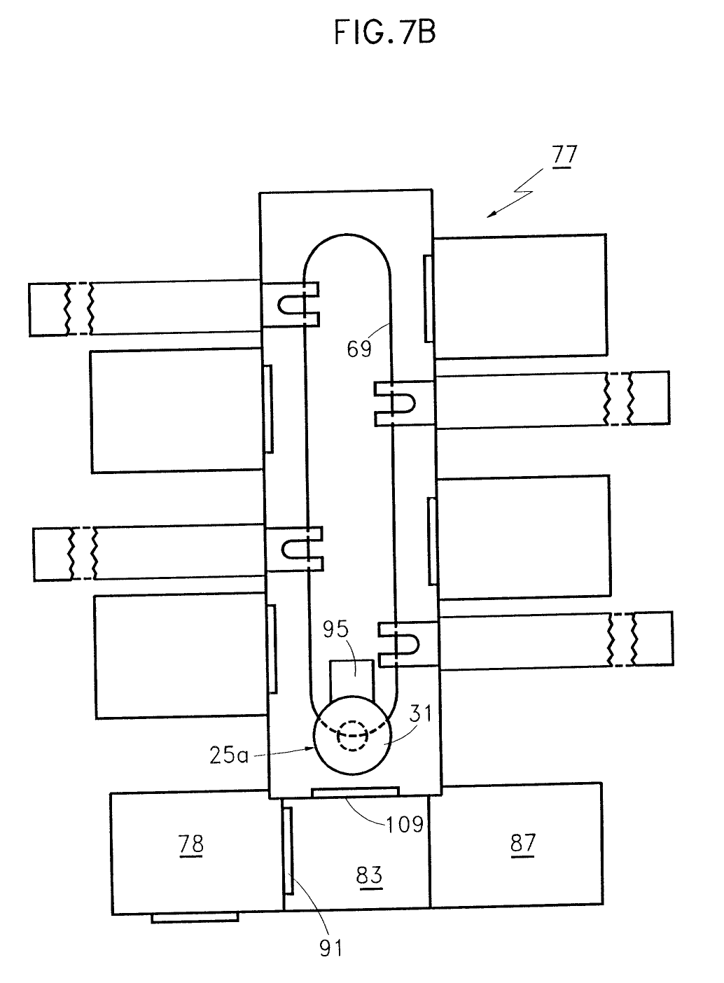

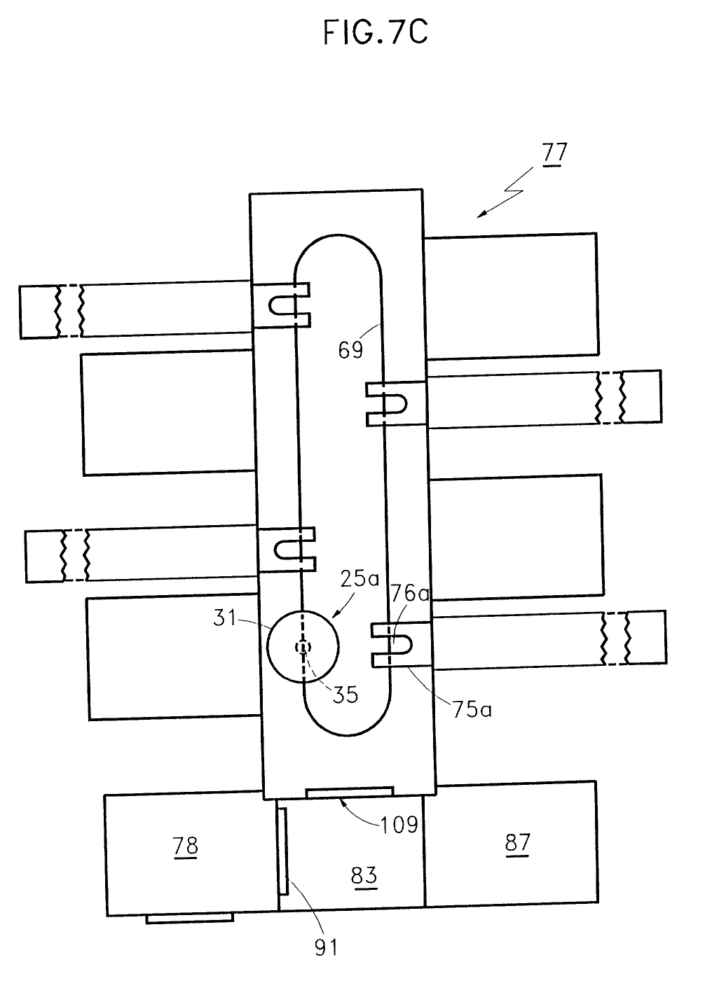

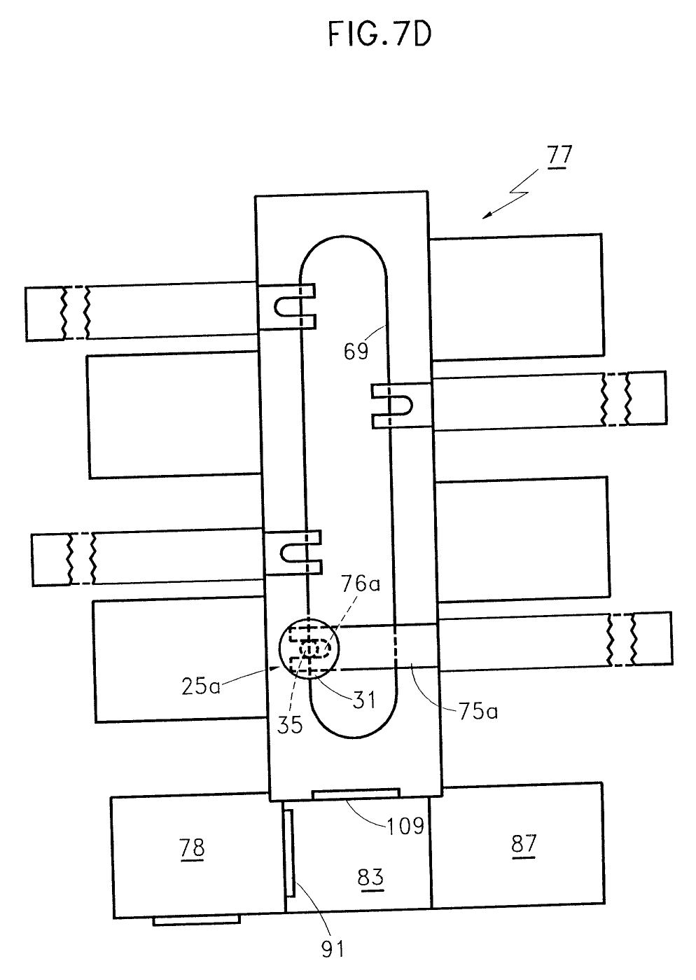

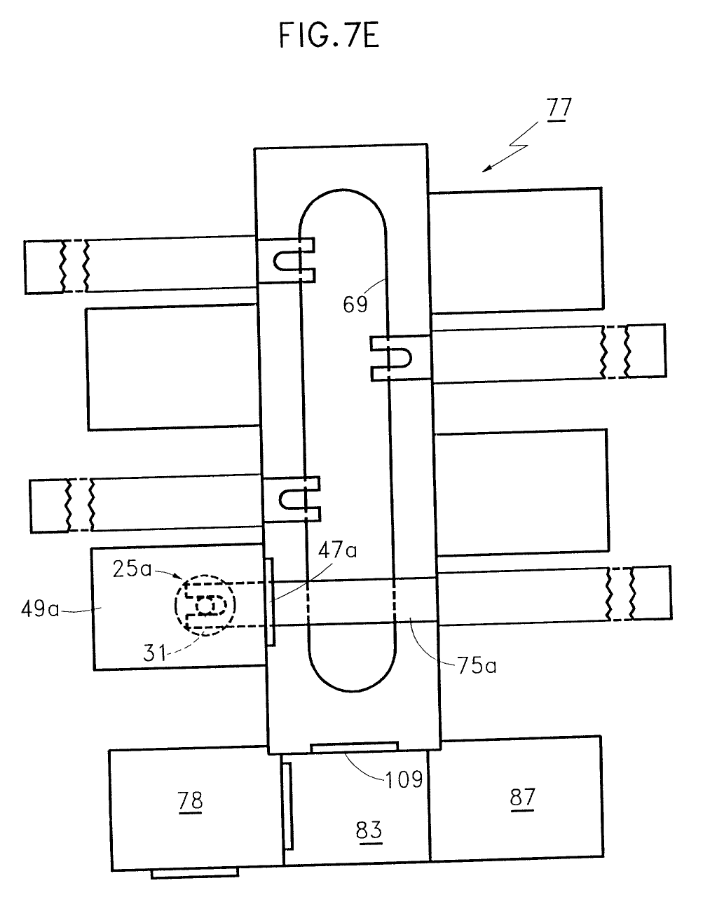

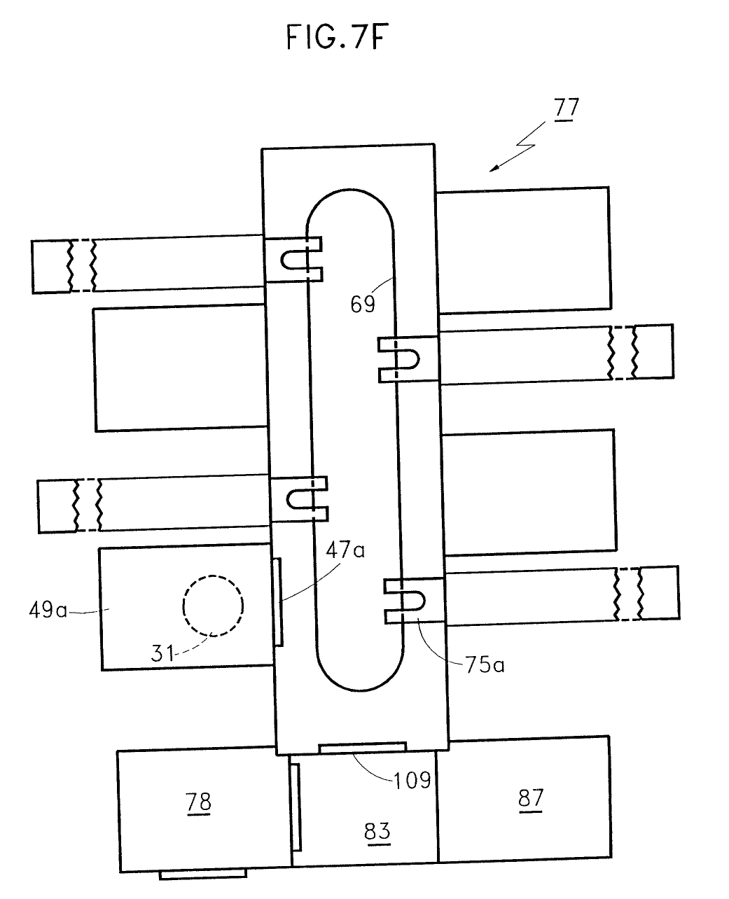

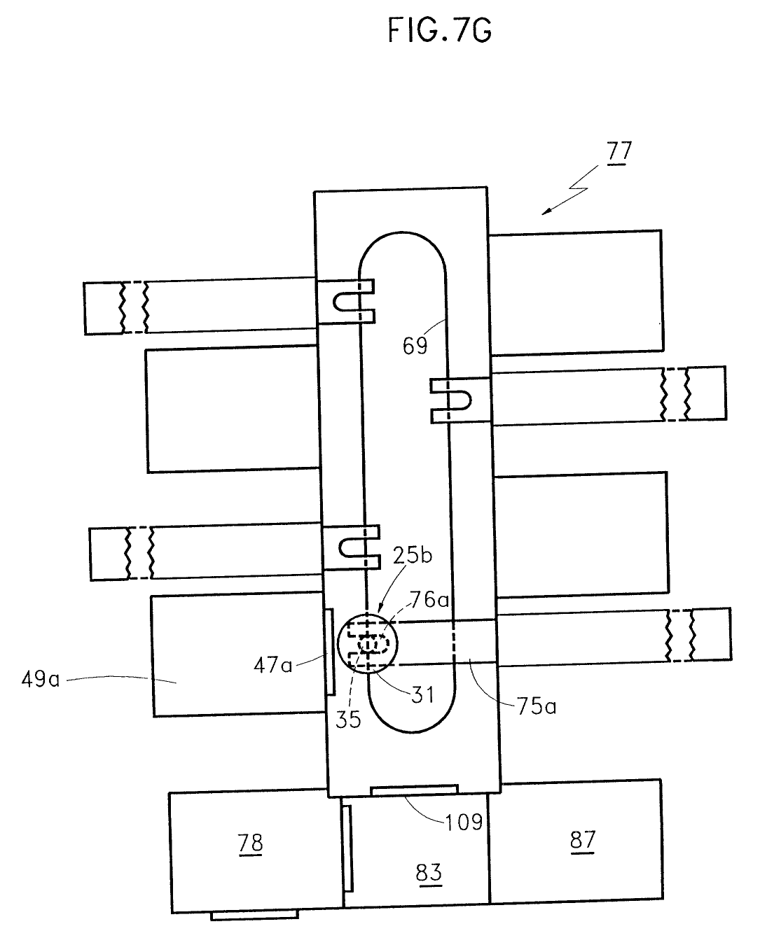

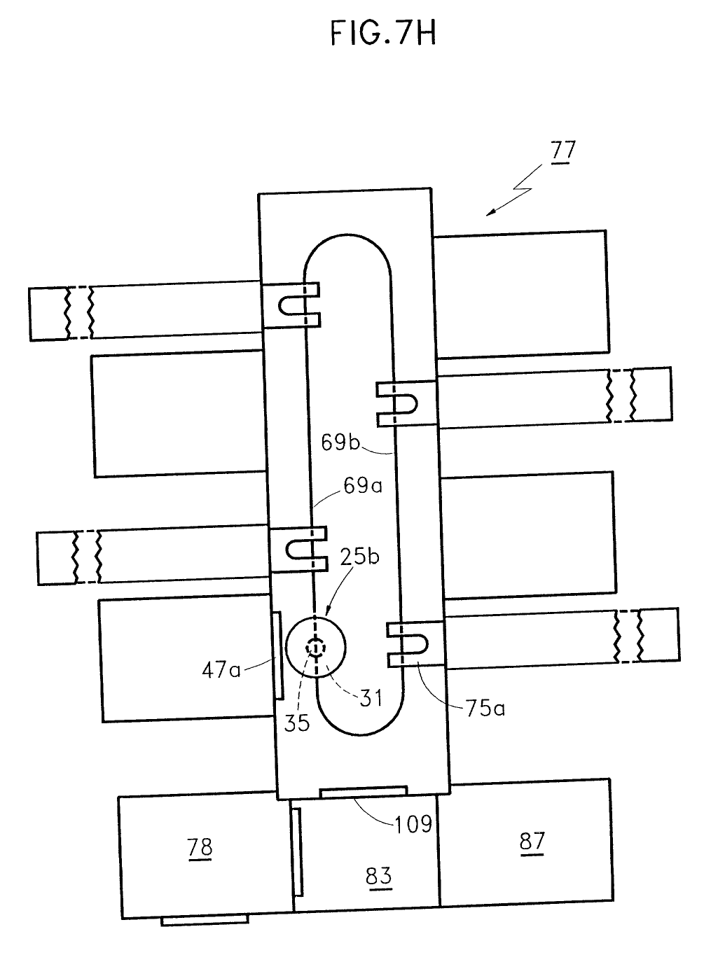

The operation of the object transport and process system 77 is described with reference to FIGS. 7A-7H. Within FIGS. 7A-7H the load lock transfer blade 95 and the network transfer blade 97 are shown only as needed, so that the operation of features located in the first, second and third planes 71a-c may be more clearly visible. In operation a cassette of wafers (not shown) is loaded through the load port 81 into the load chamber 78. The load chamber 78 is pumped to a vacuum pressure and the cassette of wafers is then passed through the first sealable port 91 into the exchange chamber 83. The first sealable port 91 closes, meanwhile, the load chamber 78 is free to receive the next cassette of wafers. Similarly, when all processing is complete and the wafers are returned to the cassette, the cassette of wafers is transferred to the unload chamber 87 where venting and unloading occur while a subsequent cassette of wafers is moved from the load chamber 78 into the exchange chamber 83. In this manner the throughput of the object transport and process system 77 is further increased.

The air cylinder drive motor (not shown) of the load lock transfer blade 95 causes the load lock transfer blade 95 to travel into the exchange chamber 83 to receive a wafer 31 and to retract carrying the wafer 31, as shown in FIG. 7A.

Next as shown in FIG. 7B, a first object transport device 25a moves along the internal track 69 (as described with reference to FIGS. 3A and 3B) at an elevation below the load lock transfer blade 95 to a position for receiving the wafer 31 from the load lock transfer blade 95. Meanwhile the load lock transfer blade 95 travels (in the fourth plane 71d) to a position just above the first object transport device 25a. The first object transport device 25a then extends (as described with reference to FIGS. 3A and 3B) and lifts the wafer 31 off of the load lock transfer blade 95.

Thereafter, as shown in FIG. 7C, the first object transport device 25a travels, initially in the fourth plane 71d and then lowering into the third plane 71c, to a position such that (with reference to FIG. 3A) the support portion 35 of the first object transport device 25a is aligned with the slot 76a of the first transfer blade 75a.

The first transfer blade 75a extends as shown in FIG. 7D such that the slot 76a receives the support portion 35 of the first object transport device 25a.

Thereafter the first object transport device 25a lowers, causing the wafer 31 to be transferred to the first transfer blade 75a. The first slit valve 47a opens and the first transfer blade 75a extends therethrough, positioning the wafer 31 above a wafer pedestal (not shown) within the first process chamber 49a, as shown in FIG. 7E.

Wafer lift pins (not shown) elevate from the top surface of the wafer pedestal (not shown) lifting the wafer 31 off of the first transfer blade 75a. The first transfer blade 75a retracts and the first slit valve 47a closes as shown in FIG. 7F.

With reference to FIG. 7G, after processing within the first process chamber 49a is complete, the first slit valve 47a opens, the wafer lift pins (not shown) elevate the wafer 31, the first transfer blade 75a extends between the wafer lift pins (not shown), and the wafer lift pins lower thereby transferring the wafer 31 onto the first transfer blade 75a. Thereafter the first transfer blade 75a partially retracts and a second object transport device 25b travels to a position beneath the first transfer blade 75a. The second object transport device 25b extends into the third plane 71c such that the support portion 35 passes through the slot 76a, lifting the wafer 31 off of the first transfer blade 75a (FIG. 7G). The transfer blade 75a then fully retracts as shown in FIG. 7H.

The wafer 31 continues traveling along the internal track 69 in the first plane 71a or in the second plane 71b, being transferred to and from process chambers located in the third plane 71c and the fourth plane 71d, in the manner described above. When the wafer 31 is finished being processed within the object transport and process system 77 it may be transferred to a remote object transport and process system (not shown), (e.g., placed within a process chamber of a remote object transport and process system or placed on an object transport device of the remote object transport and process system) by the network transfer blade 97 which operates in the same manner as the load lock transfer blade 95. Alternatively, when a pair of object transport and processing systems 77 are positioned perpendicularly, the network transfer blade may be omitted, and the object transport and processing system 77 may operate as described below with reference to FIG. 8.

Numerous wafers can be simultaneously transported and processed within the object transport and process system 77. Wafers overlap as they pass each other traveling in different planes along opposite portions of the internal track 69 (e.g., with reference to FIG. 7H, wafers overlap as they pass each other traveling in different planes along the internal track portion 69a and the internal track portion 69b). In this manner the footprint of the vacuum chamber 21 is substantially reduced as compared to conventional systems. Further, because wafer transport and process chamber load/unload occur in diverse planes; wafer transport and processing can occur asynchronously. Wafer throughput is thereby increased, as is process sequence flexibility. Finally, because the majority of moving parts are maintained outside of the vacuum chamber 21, the risk of wafer contamination due to particle generation is significantly reduced.

FIG. 8 is a top plan view of an object transport and process network 99 comprising a plurality of the object transport and process systems 77 of FIGS. 6A and 6B. As shown in FIG. 8, a first object transport and process system 77a and a second object transport and process system 77b are operatively coupled via a vacuum chamber 21. (It will be understood that the vacuum chamber 21 may further comprise a complete object transport and process system, which can be employed in the same manner as the vacuum chamber 21 to create a network.) Within the vacuum chamber 21, a first transfer blade 75a is positioned opposite a first slit valve 47a, and a second transfer blade 75b is positioned opposite a second slit valve 47b. The first slit valve 47a and the second slit valve 47b of the vacuum chamber 21 are further coupled to the sixth slit valve 47f, of the first object transport and process system 77a and the sixth slit valve 47f₂ of the second object transport and process system 77b, respectively.

In operation, after a wafer 31 has been fully processed within the first object transport and process system 77a (as described with reference to FIGS. 7A-7H), the first object transport device 25a carrying the wafer travels into alignment with the sixth slit valve 47f, of the first object transport and process system 77a. The first slit valve 47a of the vacuum chamber 21 and the sixth slit valve 47f₁ of the first object transport and process system 77a open and the first transfer blade 75a of the vacuum chamber 21 extends therethrough such that the slot 76a of the first transfer blade 75a receives the support portion 35 (see FIGS. 3A and 3B) of the first object transport device 25a. The first object transport device 25a then lowers and the wafer 31 is thereby transferred to the first transfer blade 75a. The first transfer blade 75a retracts, the first slit valve 47a and the sixth slit valve 47f₁ close. The wafer 31 is then transferred to an object transport mechanism 25 (not shown) within the vacuum chamber 21 and is thereby transported to, and transferred onto, the second transfer blade 75b (as described with reference to FIGS. 6 and 7). The second slit valve 47b of the vacuum chamber 21 and the sixth slit valve 47f₂ of the second object transport and process system 77b open, the second transfer blade 75b extends therethrough, and the wafer 31 is transferred to an object transport mechanism 25 within the second object transport and process system 77b (as shown in phantom).

Thus, the inventive vacuum chamber 21 can facilitate interconnection of a plurality of object transport and process systems 77, and can provide a method of wafer transfer therebetween that minimizes wafer handoff delays.

It will be understood that the configuration of the object transport and process network 99 is merely exemplary, and any number of the object transport and process systems 77 may be coupled together via any of the slit valves 47 (shown and described with reference to FIGS. 6A and 6B). In some applications, a first object transport and process system 77a may be advantageously coupled to a second object transport and process system 77b via a process chamber having dual slit valves that allow wafers to be directly transferred through the process chamber. Further, a plurality of process chambers 49 may be coupled via a network node 55 as shown and described with reference to FIG. 4.

The foregoing description discloses only the preferred embodiments of the invention, modifications of the above disclosed apparatus and method which fall within the scope of the invention will be readily apparent to those of ordinary skill in the art. For instance, regarding the transport device 25, the outer shaft 41 of the telescoping portion 37 may comprise a plurality of remotely controlled electromagnets located in a spaced vertical relationship, and the inner shaft 40 may comprise a magnetic material. In this manner the plurality of remotely controlled electromagnets may be selectively energized, causing the inner shaft 40 to vertically translate within the outer shaft 41. The telescoping portion 37 may thus extend and retract with virtually no particle generation.

Accordingly, while the present invention has been disclosed in connection with the preferred embodiments thereof, it should be understood that other embodiments may fall within the spirit and scope of the invention, as defined by the following claims.

The invention claimed is:

1. An object transport device located within the transfer chamber comprising:
a telescoping portion comprising a first shaft and a second shaft, the first shaft being translatably mounted to the second shaft, the telescoping portion comprising at least one translation magnet configured to cause the first shaft to translate within the second shaft;
an object support portion coupled to the telescoping portion; and
a transport magnet operatively coupled to the telescoping portion.

2. A magnetically coupled object transport system comprising:
a transfer chamber;
an object transport device located within the transfer chamber comprising:
a telescoping portion comprising a first shaft and a second shaft, the first shaft being translatably mounted to the second shaft, the telescoping portion comprising at least one translation magnet configured to cause the first shaft to translate within the second shaft;
an object support portion coupled to the telescoping portion; and
a transport magnet operatively coupled to the telescoping portion;
an external track extending adjacent the transfer chamber;
an external device movably coupled to the external track, the external device comprising a first external magnet configured to operatively couple to the at least one translation magnet of the object transport device, and a second external magnet configured to operatively couple to the transport magnet of the object transport device; and
a driving mechanism operatively coupled to the external device and configured to drive the external device along the external track.

3. The magnetically coupled object transport system of claim 2 wherein the telescoping portion further comprises a circular row of translation magnets and is operatively coupled to a circular row of transport magnets configured to cause the object transport device to rotate.

4. A transfer chamber comprising:
a first sealable port located in a first plane at a first location; and
a second sealable port located in a second plane at a second location, the first and second locations being horizontally spaced; and
an object transport device configured to transport objects between the first and second locations and between the first and second planes.

5. The transfer chamber of claim 4 wherein the object transport device comprises:
an object support portion; and
a telescoping portion coupled to the object support portion; wherein the telescoping portion is configured to telescope between the first plane and the second plane via magnetic coupling.

6. The transfer chamber of claim 5 further comprising:
a third sealable port located in the first plane at a third location, the third location being horizontally spaced from the first and second locations; and
a first object transfer mechanism mounted in the first plane in alignment with the third sealable port.

7. A transport and processing system comprising:
a transfer chamber comprising:
a first sealable port located in a first plane at a first location; and
a second sealable port located in a second plane at a second location, the first and second locations being horizontally spaced; and
an object transport device configured to transport objects between the first and second locations and between the first and second planes, the object transport device comprising:
an object support portion; and
a telescoping portion coupled to the object support portion; wherein the telescoping portion is configured to telescope between the first plane and the second plane;
a third sealable port located in the first plane at a third location, the third location being horizontally spaced from the first and second locations; and
a first object transfer mechanism mounted in the first plane in alignment with the third sealable port;
a first process chamber coupled to the first sealable port;
a second process chamber coupled to the second sealable port; and
a load lock coupled to the third sealable port.

8. The transport and process system of claim 7 further comprising a controller configured to cause the object transport device to travel in a third plane, among the first location, the second location and the third location, and configured to cause the object transport device to telescope into the first plane during object transfer to the first process chamber, and to telescope into the second plane during object transfer to the second process chamber.

9. A transport and process system network comprising:
a transfer chamber comprising:
a first sealable port located in a first plane at a first location; and
a second sealable port located in a second plane at a second location, the first and second locations being horizontally spaced; and
an object transport device configured to transport objects between the first and second locations and between the first and second planes;
a first process chamber coupled to the first sealable port; and
a remote transport and process system coupled to the second sealable port.

10. A method of transporting semiconductor wafers among a plurality of locations and among a plurality of planes, comprising:
moving a plurality of object transport devices along a track;
transporting a first object on a first object transport device along the track in a transport plane;
telescoping the first object transport device to a first process chamber load/unload plane at a first location along the track; and
loading the first object into the first process chamber while a second object transport device moves through the first location along the track in the transport plane.

11. The method of claim 10 further comprising rotating the first object transport device to align the first object.

12. The method of claim 11 wherein telescoping the first object transport device comprises rotating an extension screw portion of the first object transport device via magnetic coupling.
